(19) United States
(12) Patent Application Publication
(10) Pub. No.: US 2025/0351790 A1
(43) Pub. Date: Nov. 20, 2025

(54) Plant Watering System and Method with Low-Energy Communication

(71) Applicant: Simon Stroh, Brooklyn, NY (US)

(72) Inventor: Simon Stroh, Brooklyn, NY (US)

(21) Appl. No.: 18/668,185

(22) Filed: May 19, 2024

(51) Int. Cl. A01G 27/00; H04W 76/14

(52) U.S. Cl. CPC A01G 27/003

(57) ABSTRACT

A plant watering system and method are disclosed, wherein multiple BLE-enabled devices interact to optimize water usage. The system includes a ‘brain’ node that processes sensor data from soil moisture and temperature sensors to determine optimal watering levels, and a control node that automates the watering process based on this determination. The system enables real-time control and coordination between nodes. Additionally, the system utilizes BLE technology for wireless communication, enabling efficient and automated control, and extends battery life through low-energy operation.

### BACKGROUND OF THE INVENTION

Agricultural practices rely heavily on manual labor to manage crop growth and irrigation. This can lead to inefficiencies, errors, and waste. The invention disclosed in this application addresses these issues by providing a plant watering system that incorporates sensors, automation, and local data transmission.

Automated plant watering systems on the market today do not use a capacitive moisture reading sensor to maintain water levels. Instead, they use a combination of timers and weather forecasts to create a basic watering schedule.

However, these can be an unreliable means of watering plants since the plant only needs so much water and setting up a timer is a cumbersome process which requires trial and error. Some timer systems offer connections to weather APIs so that rainfall is accounted for and plants are not watered too much. These systems still do not account for the water actually being consumed by the plants themselves and can often overwater the plants.

Other devices or systems in the same field can be prohibitively expensive since they are at the industrial scale. They use communications with cellular towers or wireless access points which must be installed on or near the farm.

### SUMMARY OF THE INVENTION

The present invention relates to a self-regulating plant watering system comprising a soil sensor and water flow controller. The soil sensor monitors soil conditions and sends signals to the water flow controller, which adjusts water supply accordingly. The intelligent system optimizes plant growth and reduces water through real-time decision-making.

### DETAILED DESCRIPTION OF THE INVENTION

The devices use a wireless communication protocol that allows them to interact with each other and automate the process of watering plants. To connect the devices together, the devices must only be in close proximity to one another. Once they have connected, they are able to exchange information about themselves and their environment.

This connectivity and act of communication is vital to the functionality of the system.

An open protocol creates a channel of communication between devices, allowing for the exchange of information. The process begins with the device advertising that it has a service available to other devices to send and receive information. This is called a UART service, and it includes specific characteristics that allow the sending and receiving of information such as device identifiers, measurements, or other signals, formatted using the JSON data structure.

After a channel has been opened, the amount of data exchanged between the devices is limitless. This is achieved by breaking the information down into evenly sized packets. Each packet containing 20 bytes (or 20 characters). The packets are transmitted at distinctly timed intervals with a 15 millisecond wait between each interval. This ensures that neither device is overwhelmed and prevents packet loss.

Therein lies the key to how components of the system interact and create actions.

The soil sensor acts as the central decision-making component, monitoring the soil conditions and determining the optimal water level required based on those conditions. Based on the soil sensor's readings of moisture content, temperature, and other environmental factors, it determines the best watering schedule for each plant.

The real-time activation of water flow facilitates optimal plant hydration by only watering plants when needed. It optimizes not only the water being used but also the energy required to run the system. The data is only transmitted from one device to the other, using the low-energy Bluetooth wireless connection. It never leaves the proximity of the devices and isn't transferred or stored over communication towers and data centers.

This type of communication is local only, it doesn't require any wires, switches or topologies such as those used in a complex network configuration. Therefore, the only components that a user needs in order to set up the system are the devices themselves.

### Prior Art Search

In accordance with 37 CFR § 1.98, I have conducted a prior art search and found two relevant sources:
“Smart Agriculture Technology: Adapted for Varying Growing Conditions” by Simon Stroh (2021, Pennsylvania State University, https://doi.org/10.26207/q3h9-9t58)
Patent filing publication number US 2023/0200317 A1 by Aabesh De

These sources demonstrate the importance of sensor integration and data transmission in agricultural systems, but they do not describe automation in farming specifically.

### DESCRIPTION OF DRAWINGS

### Figure Legends

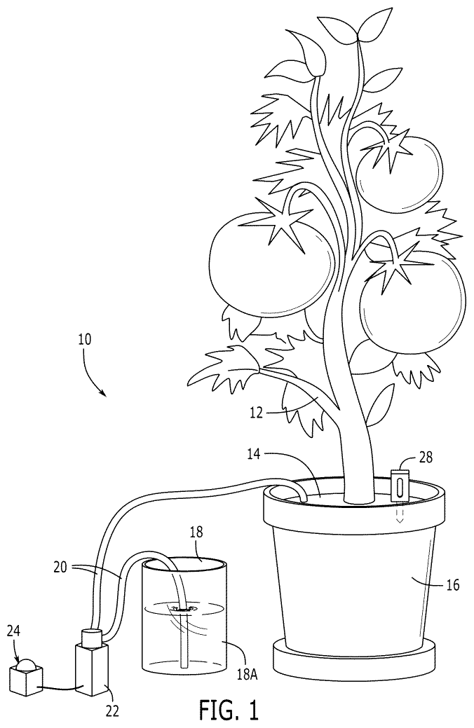

10: is the overall plant watering system with wireless communication invention.
12: is the plant.
14: is the soil.
16: is the plant pot.
18: is the water container.
18A: is water.
20: are the hoses.
22: is the pump.
24: is the microcontroller.
26: is the low-energy Bluetooth wireless communication.
28: is the moisture reading sensor.
   FIG. 1: Plant Watering System with Low-Energy Wireless Communication

This diagram illustrates the interactions between multiple BLE microcontrollers in a plant watering system with low-energy communication. The system consists of 2 BLE nodes (28, 24), each equipped with a microcontroller and sensors for monitoring soil moisture and temperature. Node 28 serves as the “brain” of the system, processing sensor data to determine optimal watering levels, while Node 24 is responsible for controlling the water flow.

The diagram highlights the following key interactions:
Direct communication: Nodes 28 and 24 interact directly via wireless connections, enabling real-time control and coordination.
Water level monitoring: Node 28 continuously monitors soil moisture levels and temperature readings, using this information to determine when the plant requires watering.
Automated control: Node 28 sends signals to Node 24 to turn on or off the water flow based on its determination of optimal watering levels.

This plant watering system leverages BLE technology for wireless communication, enabling efficient and automated control. By integrating sensors and microcontrollers, the system can optimize water usage, reduce waste, and promote healthy plant growth.

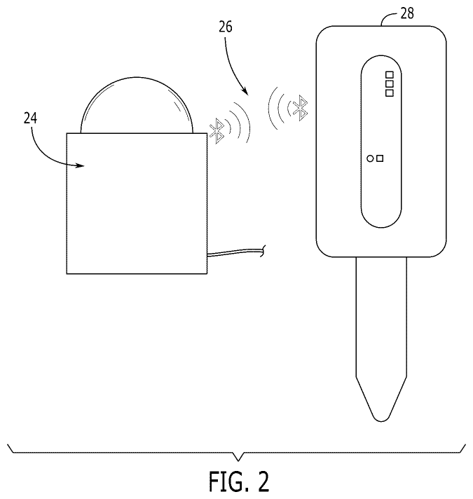

### FIG. 2: Low-Energy Communication Protocol

This figure illustrates the low-energy communication protocol (26) used in the plant watering system, showcasing how BLE (Bluetooth Low Energy) enables devices to discover and connect with each other.
Discovery and Connection: As shown, when two BLE-enabled devices are within a few inches of each other, they can automatically detect and connect to one another. This proximity-based discovery mechanism allows for efficient pairing and eliminates the need for manual configuration or setup.
Long-Distance Connectivity: The system also enables connectivity over longer distances, up to 30 meters, allowing BLE-enabled devices to maintain a stable connection even when separated by small obstacles or distances. This feature ensures that data transmission remains reliable and consistent throughout the entire watering process.
Low-Energy Operation: By leveraging BLE's low-energy capabilities, the plant watering system minimizes power consumption while maintaining connectivity. This energy-efficient approach extends battery life and reduces the overall environmental impact of the system.

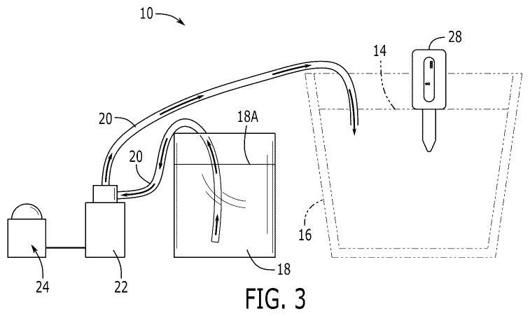

### FIG. 3: Water Flow Control

The final diagram shows how water flows through the tubes when the controller is activated. Once activated, the controller starts the flow of water by turning on the pump (22), pulling water from the reservoir (18) into the plant growth material (14).
Real-time Optimized Hydration: The connectivity between the devices ensures that when water is needed by the plant, and only when it is needed, the water flow controller can be immediately activated.
Consistent and Measurable: The system optimizes plant hydration by pumping water at a specific flow rate into the plant growth material. A consistent flow ensures that the amount of water being used can be measured accurately.

By combining the sensing device with the water flow controller, and using the low-energy wireless communication protocol, this system reduces the excessive use of water and energy. By not relying on external services, this system also removes any dependency on large infrastructures for processing information.

1. A plant watering system comprising:
(a) at least two Bluetooth Low Energy (BLE) enabled devices, each device being equipped with sensors to monitor soil moisture levels and temperature;
(b) means for enabling proximity-based discovery and connection between the BLE-enabled devices when within a short distance of each other;
(c) means for establishing connectivity over longer distances, up to approximately 30 meters; and
(d) means for controlling water flow in response to sensor readings and BLE communication.

2. A method for operating a plant watering system, comprising:
(a) monitoring soil moisture levels and temperature using sensors;
(b) enabling proximity-based discovery and connection between two or more BLE-enabled devices when within a short distance of each other;
(c) establishing connectivity over longer distances, up to approximately 30 meters; and
(d) controlling water flow in response to sensor readings and BLE communication.
